(19) United States
(12) Patent Application Publication
(10) Pub. No.: US 2026/0240220 A1
(43) Pub. Date: Aug. 20, 2026

(54) CUTTING APPARATUS FOR EXTRUDER AND PROCESS FOR PRODUCING AN EXTRUDED MATERIAL

(71) Applicant: Bühler AG, Uzwil (CH)

(72) Inventor: Florian RENNER, Allensbach (DE)

(21) Appl. No.: 19/161,926

(22) PCT Filed: Feb. 28, 2024
(86) PCT No.: PCT/EP2024/025097

§ 371 Date: Sep. 3, 2025

(30) Foreign Application Priority Data
Mar. 3, 2023 (EP) 23159982.0

(51) Int. Cl. A23P 30/20; A23K 40/25; A23N 17/00

(52) U.S. Cl. CPC A23P 30/20; A23K 40/25; A23N 17/005

(57) ABSTRACT

A cutting device for a food or feed extruder, comprising a housing having a cylindrical interior, a cutting tool, a product inlet at one end of the housing, wherein the cutting tool and the product inlet are arranged coaxially in the housing, an inlet tube and an outlet tube, wherein the inlet tube the outlet tube open into the housing from above and extend upwards away from the housing, and at least in one portion which is connected to the housing, are inclined towards one another and open obliquely into opposite lateral regions of the interior.

The present invention relates to a cutting device for an extruder, in particular an extruder for producing a food or animal feed.

Extruders are machines in which materials, such as polymers, elastomers or protein-containing mixtures, can be treated for the production of foodstuffs, including cereals, snacks, animal feeds and alternative foods under desired pressure and temperature conditions. A typical extruder comprises at least one extruder screw shaft, wherein each of the extruder screw shafts has a set of extruder screw elements mounted on a support shaft. The extruder screw shafts are accommodated in a cylinder, which is referred to as a barrel. An extruder usually comprises a plurality of barrels, which are connected to one another at the end. A plurality of barrels are required in order to carry out the different processes to be carried out in the extruder, such as conveying, kneading, mixing, degassing, dosing and the like.

A cutting device must be arranged at the outlet of the extruder for different applications. This is a unit which comprises a housing and a cutting tool arranged in the housing. The cutting tool usually comprises one or more knives which are set in a rotary motion by means of a motor and can comminute extrudate entering the cutting device.

An extruder with a cutting tool is known, for example, from EP-3 539 748 A1. Such extruders are also commercially available, for example the BCTL POLYtwin™ from Bühler. The cutting device is here preferably connected to the extruder via a fastening plate and can, for example, be displaced laterally for cleaning purposes, as a result of which the extruder outlet is accessible.

In order to remove the comminuted material from the cutting device, an air flow is usually guided through the cutting device, which discharges the material, with the assistance of gravity, through an outlet opening arranged at the bottom of the cutting device.

This known design of a cutting device has the disadvantage that a tube or a hose, which is connected to the outlet opening and receives and forwards the material discharged by the air flow, must be arranged below the cutting tool. This makes it more difficult to clean the building in which the extruder is installed. While hoses can be more flexibly and thus more easily repositioned for cleaning purposes, tubes, due to their smooth surface, are more hygienic but are also less easily repositioned.

Furthermore, in this design, the comminuted material is dispensed from the cutting device in that an air flow is introduced into the cutting device from above, flows through the cutting device vertically downwards, picks up comminuted material and leaves the cutting device with the material at the bottom. This is not optimal flow control, among other things because the air flow exerts a load on the comminuted material. The extruded material can be deformed by the impact on the housing walls and thereby reduce the product quality.

The object of the present invention was to provide a cutting device for an extruder, by means of which the above-described disadvantages of the prior art are overcome.

This object is achieved by the present invention.

In detail, the present invention relates to a cutting device for a food or feed extruder, comprising
a housing having a cylindrical interior,
a cutting tool,
a product inlet at one end of the housing, wherein the cutting tool and the product inlet are arranged coaxially in the housing,
an inlet tube and an outlet tube,
characterized in that the inlet tube and the outlet tube open into the housing from above and extend upward away from the housing and, at least in one portion which is connected to the housing, open obliquely into opposite lateral regions of the interior.

The cutting device according to the invention is characterized in that the inlet tube and the outlet tube are arranged for air to be conducted through the cutting device in such a way that the air in the cutting device is introduced or extracted from above or laterally, preferably from above, and leaves the cutting device upwards or laterally, preferably upwards. This has the advantage that tubes and hoses which are to be connected to the inlet tube and the outlet tube can be arranged above or at the side, preferably above the cutting device. The space below the cutting device remains free and can be easily cleaned or used for other purposes.

In addition, the inlet tube and the outlet tube are arranged in such a way that an air flow guided through it forms a cyclone flow in the cutting device. This leads to a more gentle and efficient dispensing of the comminuted material from the cutting device. Furthermore, the extruded material does not strike the housing walls frontally but, instead, the rotating movement of the air flow and rounding of the housing causes it to slide past the housing walls.

An upwardly oriented arrangement of inlet tube and outlet tube was realized in a device from Frazer-Nash (https://www.youtube.com/watch?v=Rd2NnqRN-FDU). However, there the inlet tube and the outlet tube were not arranged in such a way that a cyclone flow is formed within the cutting device. The air is introduced vertically from above, undergoes a flow reversal at the bottom of the cutting device and leaves the cutting device vertically upwards. The disadvantages associated with a vertical air flow through the cutting device were not detected. In addition, in this device, the cutting tool and the product inlet are not arranged coaxially in the housing of the cutting device. Rather than being transported gently, the material strikes boundary surfaces.

In order to generate the cyclone flow, the housing of the cutting device has to have a cylindrical interior. The air can flow along the inside of the lateral surface of the cylindrical interior.

The inlet tube and the outlet tube are preferably arranged on the housing of the cutting device such that they open obliquely and tangentially to the housing shell into opposite lateral regions of the interior. In this way, air comes into contact with the inside of the lateral surface of the cylindrical interior from the inlet tube, flows along it and leaves the cutting device without further deflection. The arrangement of inlet tube and outlet tube thus supports the generation of a cyclone flow in the cutting device, more precisely in its cylindrical interior. Uncontrolled turbulence of the air flow is avoided.

The above-described arrangement of inlet tube and outlet tube is preferably achieved in that the two tubes open into the housing from above and are inclined towards one another at least in a portion which is connected to the housing. The angle of inclination is preferably between 30 and 80°, particularly preferably between 45 and 70°.

It is preferred here that the tubes are inclined towards one another in a portion which is connected to the housing. This portion preferably extends up to a height of 20 cm, particularly preferably up to a height of 15 cm, starting from the outside of the housing of the cutting device. Subsequently, the inlet tube and outlet tube are preferably guided vertically upwards away from the cutting device.

The inlet tube and the outlet tube are preferably made of a material which is typically used for such tubes. Examples include a metal or a metal-containing compound, such as stainless steel.

The inlet tube and the outlet tube have a diameter as typically also used for the connecting tubes and connecting hoses from the prior art. The diameters are preferably in the range of 50-400 mm, particularly preferably 60-350 mm.

According to a preferred embodiment according to the invention, the outlet tube can have a diameter which exceeds the diameter of the inlet tube. In this way, efficient dispensing of the comminuted material can be ensured. The diameter of the outlet tube is preferably 10-50% greater than the diameter of the inlet tube.

In order to generate the cyclone flow, it is necessary for the interior of the housing of the cutting device to be cylindrical. According to a preferred embodiment of the present invention, however, the housing of the cutting device is also rounded, in particular cylindrical, i.e., it preferably has a cylindrical outer shape. In this way, a hygienic design is realized and unnecessary dead space is avoided in the housing; the housing walls can be used as a boundary of the interior.

In this preferred embodiment, the inlet tube and the outlet tube are arranged on the housing of the cutting device such that an imaginary line through an outer edge of the inlet tube and of the outlet tube is a tangent with respect to the cylindrical housing. An outer edge is to be understood here as meaning the edge of a tube which is furthest away from the other tube and is thus, in a front view from the cutting device, the outermost.

The housing is preferably made of a material which is typically used for housings of such cutting devices. Examples include a metal or a metal-containing compound, such as stainless steel.

The cutting device according to the invention has typical dimensions similar to analogous devices from the prior art.

A cutting tool is arranged in the cutting device. Said cutting tool is preferably one or more knives which are arranged rotatably in the interior of the housing of the cutting device. This is conventionally known.

The cutting tool is connected to a motor which can set the cutting tool in the desired motion, for example in the rotary motion described above. The motor is arranged at one end of the cutting device and, for example, connected to the cutting tool via a shaft. This is well known.

The cutting device also has a product inlet in the form of an opening, which can be fluidically connected to the outlet of an extruder, so that extruded material from the extruder can reach the cutting device. This product inlet is preferably arranged in the lateral face of the cutting device which is opposite the lateral face on which the motor is arranged.

According to a preferred embodiment of the present invention, the product inlet in the cutting device is designed such that the extruder head (i.e., the end of the extruder facing away from the drive) can project with the extruder outlet through this opening into the interior of the housing of the cutting device. In this way, extruded material can pass directly into the interior without coming into contact with an edge of the product inlet.

According to a particularly preferred embodiment of the present invention, the product inlet in the cutting device and the cutting tool in the cutting device are arranged coaxially. In other words, the product inlet in the cutting device has a round cross section with a central axis, and the cutting tool has a circular shape with likewise a central axis, wherein both central axes coincide. The cutting tool is arranged directly upstream of the product inlet, so that material entering the interior of the housing of the cutting device reaches the cutting tool directly and gently without contact with surfaces. However, a somewhat offset arrangement of the cutting tool is also conceivable, so that an eccentric cutting can be carried out.

The cutting device according to the invention has means for fastening the cutting device to an extruder. Preferably, these are detachable fastening means such as screws, so that the cutting device can be removed from the extruder, for example, for maintenance purposes or for replacement. Preferably, the cutting device according to the invention can be releasably connected to the extruder, or a cooling tool arranged on the extruder, via a fastening plate, as described, for example, in EP-3-539-748 A1.

According to a further preferred embodiment, the cutting device according to the invention is hinged. With such an embodiment, the housing of the cutting device preferably consists of two parts which are connected to one another by means of a closure. If the closure is released, a part can be pivoted away from the other part via a hinge. The interior of the cutting device is thereby accessible, for example for cleaning or maintenance purposes.

The cutting device according to the invention can be arranged on any conventional extruder.

The present invention thus also relates to an extruder comprising a cutting device according to the invention described above.

Extruders are well known. Reference is made, for example, to WO 2012/158023 A1 or to Bühler extruders, in particular twin-screw extruders. Such extruders preferably have an L/D ratio (total length to screw diameter) in the range of 12-60, preferably 20 to 40. According to the invention, the extruders are preferably operated at 100 to 1000 rpm, particularly preferably at 200 to 600 rpm, and particularly preferably at 250 to 350 rpm.

The extruder according to the invention comprises a motor with a transmission in order to drive the extruder screws. For this purpose, the support shaft of each existing extruder screw is operatively connected to the gear unit.

This can be done in a conventionally known manner. The extruder according to the invention furthermore comprises an extruder housing with a process zone located in the housing and an inlet and outlet. The extruder housing preferably comprises 2 to 20 barrels, more preferably 2 to 15 barrels. The barrels are preferably connected to one another at their front ends and together form the extruder housing.

The extruder housing (or each of the barrels forming the extruder housing) has a through-hole. The through-hole passes through the extruder housing axially through its entire length. The process zone of the extruder is located within this through-hole.

The housing of the extruder is preferably temperature-controlled. The material to be extruded is kneaded under pressure (usually from 1 to 400 bar, preferably from 1 to 200 bar) in order to form a homogeneous mixture. In this case, an energy consumption of 10 to 150 Wh/kg, preferably 10 to 120 Wh/kg, particularly preferably 15 to 30 Wh/kg, is generally operated.

The inlet of the extruder serves to introduce raw materials into a first portion of the extruder. This inlet opens into the process zone. The inlet is usually and preferably located on the extruder housing, so that material can reach the extruder housing, more precisely the process zone of the extruder, under the effect of gravity.

The material to be extruded can be added directly into the process zone through the inlet. A metering device is preferably located above the inlet, with which metering device the material to be extruded is metered and optionally mixed before it is guided through the inlet. According to the invention, the material to be extruded can preferably be pretreated beforehand in a conventional preconditioner and sup-plied from this to the inlet, for example by means of a conventional screw conveyor.

At the end of the process zone remote from the inlet, there is an outlet through which the extruded material leaves the extruder. The outlet is connected to the process zone.

The extruder typically also has a water supply line, an oil supply line and optionally a steam supply line.

According to a preferred embodiment of the present invention, a cooling tool, such as a cooling nozzle, can be provided at the outlet of the extruder. Cooling tools for extruders are well known. A known distributor unit can preferably be arranged between the extruder and the cooling tool.

As described above, the cutting device according to the invention is arranged at the outlet end of the extruder or at the outlet end of a cooling tool provided at the outlet end of the extruder, provided that a cooling tool is present.

In the event that a cooling tool is present, the above statements relating to the extruder head apply analogously to the end of the cooling tool. In other words, one end of the cooling tool then preferably projects through the product inlet of the cutting device into the interior of the housing of the cutting device.

As explained above, the cutting device according to the invention is releasably connected to the extruder or to the cooling tool via a fastening plate.

The cutting device can furthermore have a carrier with which the cutting device can be supported on the floor of a building, such as a hall.

The present invention further relates to an extrusion line comprising an extruder according to the preceding description and at least one unit selected from the group consisting of a gas feed unit connected to the inlet tube of the cutting device and a gas outlet unit connected to the outlet tube of the cutting device.

As described above, a cyclone flow is generated in the cutting device during the intended use. A cyclone flow is a circular flow around a central point, analogous to a vortex tower.

In order to generate the cyclone flow, according to one embodiment of the present invention, air can be guided through the inlet tube into the interior of the cutting device by means of a gas feed unit. This is typically done by introducing a compressed air flow. The gas feed unit is therefore preferably a unit in which air can be compressed and released under pressure. A pump is one example thereof.

According to another embodiment of the present invention, however, the cyclone flow can also be generated by extracting air from the interior of the housing of the cutting device through the outlet tube. The gas discharge unit is therefore preferably an air intake unit, such as a pump.

Even if the cyclone flow is generated by introducing compressed air into the interior of the housing of the cutting device, a gas discharge unit described above can be provided in order to support the dispensing of the material from the cutting device.

The inlet tube and the outlet tube can be connected to known supply, discharge or further processing devices. Since, according to the invention, the inlet tube and outlet tube extend laterally or particularly preferably upwards away from the cutting device, the corresponding connecting lines can be arranged above the extrusion line, without it taking up space on the floor of the building in which the extrusion line is set up. This allows easier cleaning of the floor below the extrusion line, because there are no tubes or hoses on the floor.

The present invention further relates to a method for producing an extruded material with an extruder according to any of claims 5 to 9, comprising the steps of:
extruding the material in the extruder,
transferring the extruded material from the extruder into the cutting device,
cutting the extruded material in the cutting device, and
discharging the extruded material from the cutting device by means of a cyclone flow.

As described above, the cyclone flow can be generated by introducing gas into the interior of the housing of the cutting device through the inlet tube of the cutting device.

Alternatively, as described above, the cyclone flow can be generated by extracting gas from the interior of the housing of the cutting device through the outlet tube of the cutting device.

According to the invention, the cutting device is preferably operated with hot air which, for example, has a temperature in the range of 20 to 150° C., preferably of 50 to 100° C.

According to the invention, all foodstuffs or animal feeds, which are usually produced by extrusion, can be produced. Examples include protein-containing mixtures for the production of foods, including cereals, snacks, animal feeds and alternative foods (such as alternative meat and fish products).

The present invention is described in more detail below on the basis of non-limiting exemplary embodiments with reference to figures. In the figures, the same reference signs designate the same elements. In the figures:

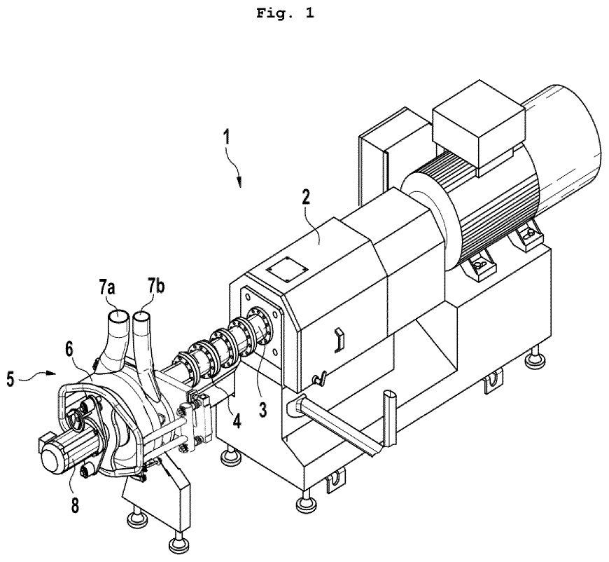

FIG. 1 shows a schematic view of an embodiment of an extruder according to the invention

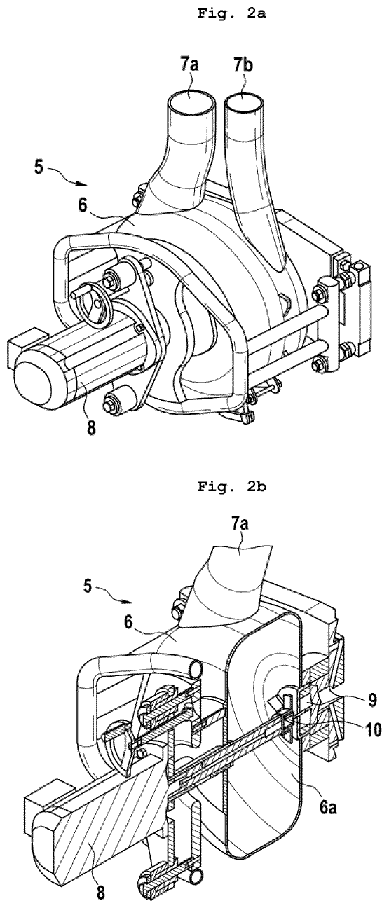

FIG. 2a shows a schematic view of an embodiment of a cutting device according to the invention in the closed state

FIG. 2b shows a schematic view of a section through an embodiment of a cutting device according to the invention

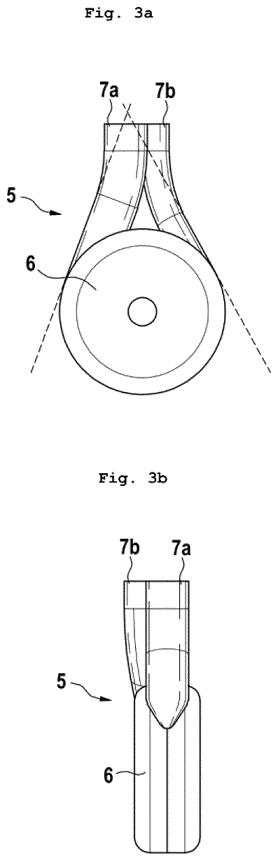

FIG. 3a shows a front view of an embodiment of a cutting device according to the invention

FIG. 3b shows a side view of an embodiment of a cutting device according to the invention

FIG. 3c shows a plan view of an embodiment of a cutting device according to the invention

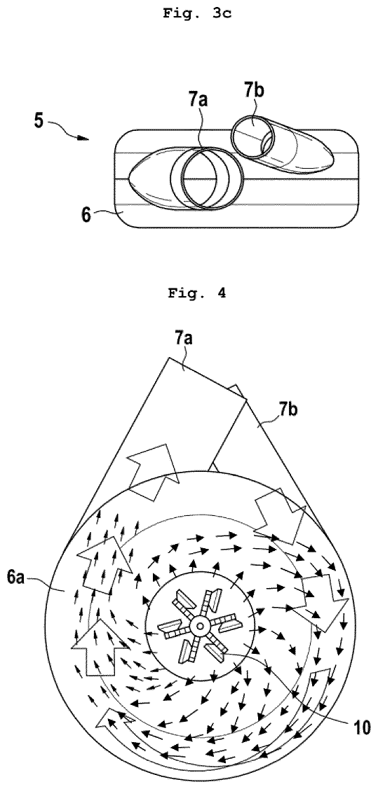

FIG. 4 shows a schematic representation of the cyclone flow in the cutting device

FIG. 1 is a schematic view of an embodiment of an extruder 1 according to the invention. The extruder 1 comprises a drive unit 2 with a motor and a gear unit for driving an extruder shaft (not shown) arranged in the extruder 1. Material to be processed can be fed into the process zone 4 of the extruder 1 through the inlet 3. The process zone 4 is constructed from a plurality of barrels. In the process zone 4, the material is processed as desired by means of an extruder screw.

The processed material enters the cutting device 5 from the extruder 1. The cutting device 5 comprises a housing 6, an inlet tube 7b arranged on the housing 6 and an outlet tube 7a arranged on the housing 6. The inlet tube 7b and the outlet tube 7a are inclined towards one another in their lower portions. A motor 8 for operating a cutting tool (not shown here) arranged in the cutting device 5 is provided at the end of the cutting device 5 remote from the extruder 1.

FIG. 2a shows a schematic view of an embodiment of a cutting device 5 according to the invention in the closed state. As in FIG. 1, the housing 6 is cylindrical or alternatively rounded. The inlet tube 7b and the outlet tube 7a are arranged on top of the housing 6 in such a way that an imaginary line through an outer edge of the inlet tube 7b and the outlet tube 7a is a tangent with respect to the cylindrical housing 6. This is explained in more detail below in FIG. 3a.

FIG. 2b shows a schematic view of a further sectional view of a cutting device 5 according to the invention. In the housing 6, there is an interior 6a into which the inlet tube 7b (not shown) and the outlet tube 7a open from above and obliquely into opposite lateral regions of the interior 6a. A product inlet 9, through which material can be introduced from the extruder 1 into the interior 6a, is arranged at one end of the cutting device 5. A cutting tool 10 is furthermore provided in the interior 6a, preferably coaxially to the product inlet 9.

FIG. 3a shows a front view of an embodiment of a cutting device 5 according to the invention. It can be seen that the inlet tube 7b and the outlet tube 7a are arranged on top of the housing 6 in such a way that an imaginary line (shown here by dashed lines) through an outer edge of the inlet tube 7b and the outlet tube 7a is a tangent with respect to the cylindrical housing 6.

FIG. 3b shows a side view of an embodiment and in FIG. 3c a plan view of an embodiment of a cutting device 5 according to the invention. It can be seen that the inlet tube 7b and the outlet tube 7a are arranged somewhat offset relative to one another in the longitudinal direction of the cutting device.

FIG. 4 shows a schematic representation of the cyclone flow in the cutting device 5. Air flows obliquely through the inlet tube 7b into the interior 6a and along the rounded or cylindrical lateral surface of the interior 6a up to the outlet tube 7a, where the air (together with comminuted material) leaves the cutting device 5. The cutting tool 10 is also shown.

### LIST OF REFERENCE SYMBOLS

1 Extruder
2 Drive
3 Inlet
4 Process zone
5 Cutting device
6 Housing
6a Interior
7a Outlet tube
7b Inlet tube
8 Motor
9 Product inlet
10 Cutting tool

1. A cutting device for a food or feed extruder, comprising:
a housing having a cylindrical interior,
a cutting tool,
a product inlet at one end of the housing, wherein the cutting tool and the product inlet are arranged coaxially in the housing,
inlet tube and an outlet tube,
wherein the inlet tube and the outlet tube open into the housing from above and extend upwards away from the housing and, at least in one portion which is connected to the housing, open obliquely into opposite lateral regions of the interior.

2. The cutting device according to claim 1, wherein the housing is rounded, in particular cylindrical.

3. The cutting device according to claim 2, wherein an imaginary line through an outer edge of the inlet tube and the outlet tube is a tangent with respect to the cylindrical housing.

4. The cutting device according to claim 1, wherein the cutting device comprises a motor for driving the cutting tool.

5. An extruder comprising a cutting device according to claim 1.

6. The extruder according to claim 5, wherein the cutting device is arranged at the outlet end of the extruder or at the outlet end of a cooling tool provided at the outlet end of the extruder.

7. The extruder according to claim 6, wherein the cutting device is releasably connected to the extruder or to the cooling tool via a fastening plate.

8. The extruder according to claim 5, wherein the inlet tube and the outlet tube of the cutting device are connected to lines or tubes which lead upwards away from the cutting device.

9. The extruder according to claim 5, wherein the end of the extruder or of the cooling tool extends into the housing of the cutting device.

10. An extrusion line comprising an extruder according to claim 5 and at least one unit selected from the group consisting of a gas feed unit connected to the inlet tube of the cutting device and a gas outlet unit connected to the outlet tube of the cutting device.

11. A method for producing an extruded material having an extruder according to claim 5, comprising the steps of:
extruding the material in the extruder,
transferring the extruded material from the extruder into the cutting device,
cutting the extruded material in the cutting device, and
discharging the extruded material from the cutting device by means of a cyclone flow.

12. The method according to claim 11, wherein the cyclone flow is generated by introducing gas into the interior of the housing of the cutting device through the inlet tube of the cutting device.

13. The method according to claim 11, wherein the cyclone flow is generated by extracting gas from the interior of the housing of the cutting device through the outlet tube of the cutting device.
